(19) United States
(12) Patent Application Publication
(10) Pub. No.: US 2002/0008062 A1
(43) Pub. Date: Jan. 24, 2002

(54) Portable water purifier

(76) Inventor: Kenji Torigoe, Nagoya (JP)

Correspondence Address: ARENT FOX KINTNER PLOTKIN & KAHN, PLLC, Suite 600, 1050 Connecticut Avenue, N.W., Washington, DC, 20036-5339, US

(21) Appl. No.: 09/854,921

(22) Filed: May 15, 2001

(30) Foreign Application Priority Data
May 19, 2000 (JP) 2000-148739

(51) Int. Cl. B01D 35/00

(52) U.S. Cl. 210/416.3

(57) ABSTRACT

The invention provides a portable simple water purifier with simple operation and high motivation of use. A main unit A including an intake port 3 for sucking in raw water, which also serves as an ejection port for ejecting treated water, is used on tap water with residual chlorine, for which there are concerns regarding consumption. An attachment B is used for water of poor quality including suspended particles.

### BACKGROUND OF THE INVENTION

1. Field of the Invention

The present invention relates to a portable water purifier for producing water that is suitable for drinking.

2. Description of the Related Art

The quality of tap water in Japan has a good reputation and it is safe to drink it, but as the awareness for water quality and problems regarding pollution of water sources rises, water purifiers are becoming increasingly popular.

However, water purifiers are far from being installed everywhere, and even when all drinking water at home is treated with a water purifier, one is often forced to drink untreated water outside the home.

With a portable water purifier, it is possible to produce treated water regardless of the place, which can be very convenient. Hitherto, portable water purifiers as for example in JP S64-5615U and JP H07-313972A have been proposed.

In all of these conventional portable water purifiers, a supply port arranged on an opposite side with respect to an ejection port is opened, raw water is filled into the supply port, and treated water is ejected by a pressure application means from the ejection port. This configuration provides sufficient performance when used for outdoor activities, but the operation of filling the water purifier with raw water is cumbersome, because the supply port has to be opened and closed, and to fill the portable water purifier with water, the water has to be given into a cup and then poured into the water purifier, so that water is easily spilled.

Therefore, the conventional portable water purifiers are difficult to use when treating for example Japanese tap water, which is safe to drink, or the local water in foreign countries, which does not affect the human body when imbibed in moderate amounts, so that the motivation to use a water purifier is reduced, and as a result, untreated water is often consumed even though a water purifier is available.

### SUMMARY OF THE INVENTION

It is a purpose of the present invention to provide a portable water purifier that is easy to handle and has high functionality. In accordance with the present invention, a portable water purifier includes a variable-volume chamber; an intake port, also serving as an ejection port, provided at the variable-volume chamber; and a filter material arranged at a border portion between the intake port and the variable-volume chamber, the filter material having copper fiber as a main component; wherein a purpose of the portable simple water purifier is to eliminate residual chlorine in water and sterilize the water by passing the water twice through the filter material, namely when the water is sucked through the intake port into the variable-volume chamber by an operation enlarging the variable-volume chamber, and when the water that has been sucked into the variable-volume chamber is ejected through the intake port by an operation compressing the variable-volume chamber.

The portable water purifier of the present invention can further include an attachment for adapting the portable water purifier to use during disasters or leisure time, which is provided in attachable-detachable manner on the intake port, the attachment being divided into two branches from the intake port, and comprising a first check valve that closes during intake in one branch, and a filter and a second check valve that closes during ejection in the other branch.

### BRIEF DESCRIPTION OF THE DRAWINGS

FIG. 1 is a diagram illustrating the main unit of a portable water purifier in accordance with the present invention.

FIGS. 2(a) and 2(b) are diagrams illustrating usage examples of the portable water purifier.

FIGS. 3(a) and 3(b) are diagrams illustrating an attachment mounted on the main unit.

FIGS. 4(a) and 4(b) are diagrams illustrating the water flow when the attachment is mounted.

### DESCRIPTION OF THE PREFERRED EMBODIMENTS

The following is an explanation of an embodiment of a portable water purifier in accordance with the present invention, with reference to the accompanying drawings.

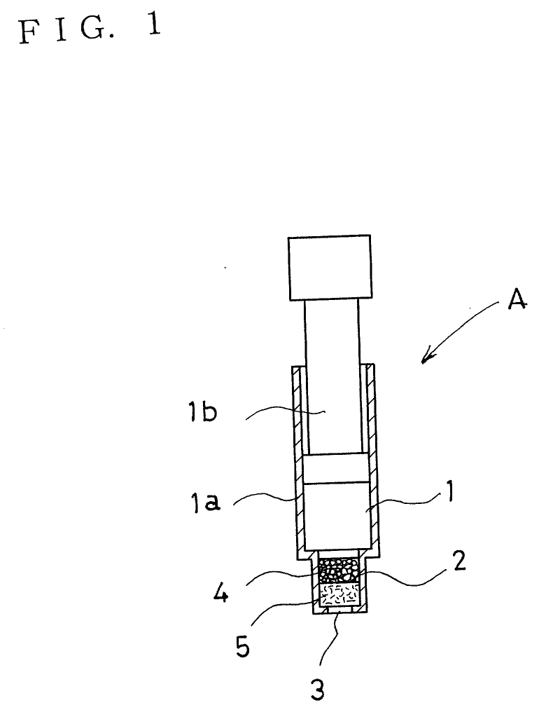

In FIG. 1, “A” denotes a syringe-type main unit including a tubular cylinder 1a and a piston 1b. In this main unit A, a variable-volume chamber 1 is provided, whose volume can be varied by sliding the piston 1b with respect to the cylinder 1a. A filter chamber 2 is arranged at the front end of the cylinder 1a, coaxially and in communication with the cylinder 1a. An intake port 3, also serving as an outlet port, is formed in the middle of the front end of the filter chamber 2.

The filter chamber 2 is filled with a main filter material 4 made of copper fiber, and an auxiliary filter material 5 made of activated carbon, calcium sulfite, etc.

The main filter material 4 made of copper fiber has excellent sterilization and dechlorination ability, and is very advantageous for the extermination of germs contained in water and the elimination of residual chlorine contained tap water.

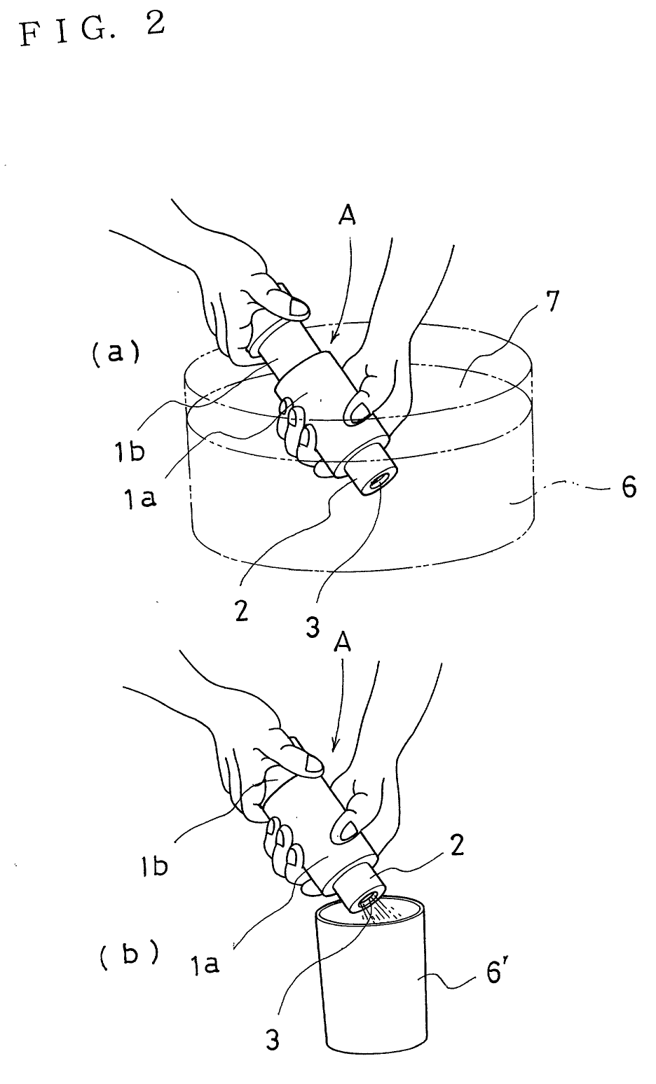

The method of using the main unit A is rather simple: The intake port 3 is inserted into a suitable container 6 and immersed in raw water 7, and then raw water 7 is sucked through the intake port 3 into the volume-variable chamber 1 by pulling the piston 1b out (see FIG. 2(a)).

During the intake step of sucking in the raw water 7 through the intake port 3 into the volume-variable chamber 1, the raw water 7 passes through the main filter material 4 and the auxiliary filter material 5, whereby water containing germs is sterilized and water containing large amounts of residual chlorine is dechlorinated.

When a predetermined amount of raw water 7 has been sucked into the volume-variable chamber 1, treated water can be returned through the intake port 3 into the container 6 by pushing the piston 1b back into the cylinder 1a, or the intake port 3 can be taken out of the raw water 7, placed at the aperture of another container different from the container 6, for example a cup 6′, and the treated water can be ejected from the intake port 3 and poured into that container (see FIG. 2(b)).

The sterilization and elimination of residual chlorine is also carried out during this ejection step, so that as a result, it is possible to obtain pure water, which has been subjected twice to sterilization and elimination of residual chlorine, simply by stroking the piston back and forth.

Thus, people who are particular about their water can feel a sense of security and satisfaction by treating with the above-described method water that contains a lot of residual chlorine (even though it may be labeled as “drinking water”), such as tap water of high water quality, or water containing germs.

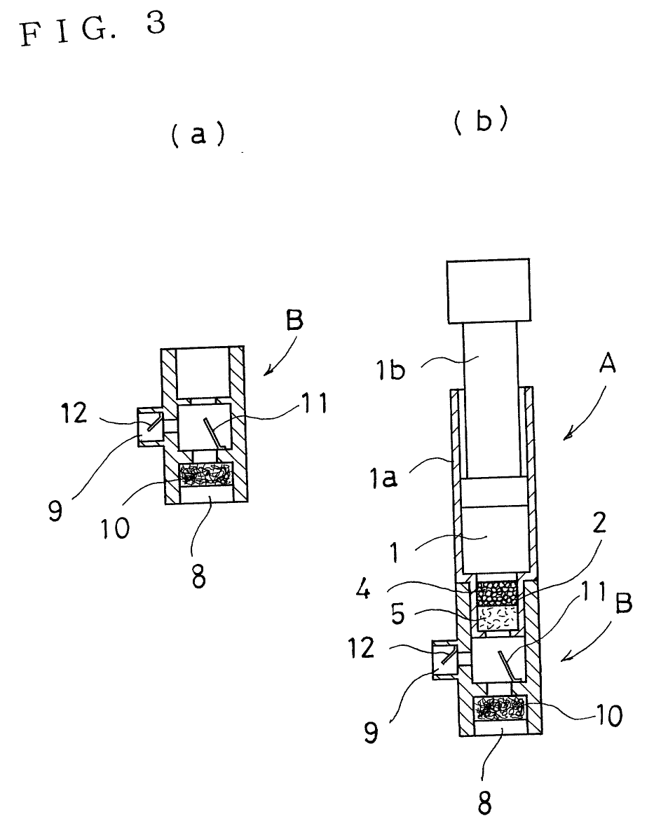

An attachment B can be mounted in a attachable/detachable manner on the intake port of the main unit A of the water purifier, as shown in FIG. 3(a).

This attachment B is tubular, and by matching its inner diameter with the outer periphery of the filter chamber 2 in the main unit A, it is configured to be attachable/detachable with respect to the intake port 3 of the main unit A. An intake-only port 8 is provided at the front end and an ejection-only port 9 protrudes from the side of the attachment B, thus branching the intake port 3 into two branches when the attachment B is mounted on the main unit A. A filter 10 and a check valve 11 that closes during ejection are provided at the intake-only port 8, whereas a check valve 12 that closes during intake is provided at the ejection-only port 9.

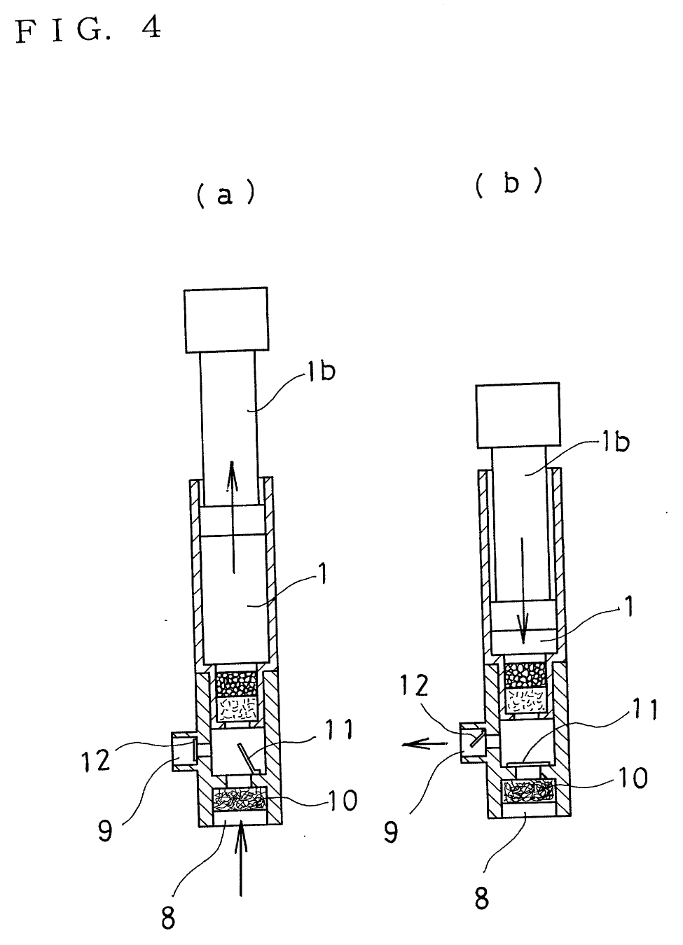

When the attachment B is mounted on the main unit A as shown in FIG. 3(b), and the piston 1b is pulled out, the ejection-only port 9 is shut by the check valve 12, and raw water, from which suspended particles have been eliminated, germs have been killed and residual chlorine has been eliminated, is sucked through the intake-only port 8 into the variable-volume chamber 1 (see FIG. 4(a)). And when the piston 1b is pushed back in again, the intake-only port 8 is shut by the check valve 11 provided in the intake-only port 8, and the raw water that has been sucked into the variable-volume chamber 1 is again subjected to sterilization and elimination of residual chlorine, and ejected as treated water from the ejection-only port 9 (see FIG. 4(b)).

The attachment B is used with the purpose of obtaining drinking water by eliminating suspended particles with the filter 10 when sucking raw water through the intake-only port and ejecting it through the ejection-only port, for example in case of disaster, when it is difficult to ensure a steady level of water quality and when suspended particles are mixed into the raw water.

Also, a preferable way of usage is to connect a tube to the protruding portion of the ejection port and insert the front end of this tube into a container, such as a pitcher, so that suspended particles that adhere to the filter are not mixed with the treated water.

In this example, the main unit was devised as a hand-operated syringe-type, but it can also be of a bellows-shaped pipet-type. Moreover, instead of a manual operation, it can also be devised to be operated electrically, by moving the piston with a crank mechanism or the like.

It is preferable that the filter chamber is attachable/detachable with respect to the variable-volume chamber, so that the filter material can be exchanged easily, but it does not necessarily have to be independent, and it is also possible to use the portion including the border of the variable-volume chamber with the intake port.

Furthermore, the auxiliary filter material is not limited to this example, and it is also possible to devise it as a cartridge to make it replaceable with a simple operation, or to use natural rock or man-made porous ceramics or the like.

With the portable water purifier in accordance with the present invention, it is possible to treat water in a simple manner at any place, and it is possible to process tap water that contains a lot of residual chlorine, even though it may be labeled as “drinking water”, into pure water without chlorine smell, or to sterilize water, for which there are concerns regarding drinkability.

Furthermore, using the attachment, it becomes possible to turn water of poor water quality into drinking water by filtering out suspended particles with a filter.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description. All changes that come within the meaning and range of equivalency of the claims are intended to be embraced therein.

What is claimed is:

1. A portable water purifier, comprising:
a variable-volume chamber;
an intake port, also serving as an ejection port, provided at the variable-volume chamber; and
a filter material arranged at a border portion between the intake port and the variable-volume chamber, the filter material having copper fiber as a main component;
wherein a purpose of the portable water purifier is to eliminate residual chlorine in water and sterilize the water by passing the water twice through the filter material, namely when the water is sucked through the intake port into the variable-volume chamber by an operation enlarging the variable-volume chamber, and when the water that has been sucked into the variable-volume chamber is ejected through the intake port by an operation compressing the variable-volume chamber.

2. The portable water purifier according to claim 1, further comprising an attachment for adapting the portable water purifier to use during disasters or leisure time, which is provided in attachable-detachable manner on the intake port, the attachment being divided into two branches from the intake port, and comprising a first check valve that closes during intake in one branch, and a filter and a second check valve that closes during ejection in the other branch.
